(19) United States
(12) Patent Application Publication
(10) Pub. No.: US 2023/0388219 A1
(43) Pub. Date: Nov. 30, 2023

(54) IGP Extensions for BIER-TE

(71) Applicant: Huawei Technologies Co., Ltd., Shenzhen (CN)

(72) Inventor: Huaimo Chen, Bolton, MA (US)

(21) Appl. No.: 18/448,757

(22) Filed: Aug. 11, 2023

Related U.S. Application Data
(63) Continuation of application No. PCT/US2022/015805, filed on Feb. 9, 2022.
(60) Provisional application No. 63/148,974, filed on Feb. 12, 2021.

(51) Int. Cl. H04L 45/16; H04L 45/122; H04L 12/18

(52) U.S. Cl. CPC H04L 45/16; H04L 45/122; H04L 12/18

(57) ABSTRACT

A method implemented by a network node in a Bit Index Explicit Replication Traffic Engineering (BIER-TE) domain. The method includes encoding a bit position configured on a link in a bit position field of a BIER-TE sub-type length value (sub-TLV), and distributing the BIER-TE sub-TLV in the BIER-TE domain. The BIER-TE sub-TLV is compatible with OSPFv2, OSPFv3, and IS-IS protocols.

### CROSS-REFERENCE TO RELATED APPLICATIONS

This patent application is a continuation of International Application No. PCT/US2022/015805 filed on Feb. 9, 2022, which claims the benefit of U.S. Provisional Patent Application No. 63/148,974 filed Feb. 12, 2021, each of which is hereby incorporated by reference.

### TECHNICAL FIELD

The present disclosure is generally related to the field of traffic engineering and, in particular, to Interior Gateway Protocol (IGP) extensions for Bit Index Explicit Replication-Traffic Engineering (BIER-TE).

### BACKGROUND

BIER mechanisms provide optimized forwarding of multicast data packets through a BIER domain. BIER domains may not require the use of a protocol for explicitly building multicast distribution trees. Further, BIER domains may not require intermediate nodes to maintain any per-flow state. BIER is described in further detail in Internet Engineering Task Force (IETF) document Request for Comments (RFC) 8279 entitled “Multicast Using Bit Index Explicit Replication (BIER)” by U. Wijnands, et al., published November 2017.

Traffic Engineering (TE) is the process of steering traffic across to a telecommunications network to facilitate efficient use of available bandwidth between a pair of routers. Bit Index Explicit Replication (BIER) Traffic/Tree Engineering (BIER-TE) is described in IETF document “Tree Engineering for Bit Index Explicit Replication (BIER-TE)” by T. Eckert, et al., published Jul. 9, 2021.

### SUMMARY

The disclosed aspects/embodiments provide IGP extensions for BIER-TE. The IGP extensions are utilized to distribute bit positions for forward connected adjacencies configured on the links in a BIER-TE domain. Therefore, packet routing within the BIER-TE domain is improved.

A first aspect relates to a method implemented by a network node in a Bit Index Explicit Replication Traffic Engineering (BIER-TE) domain, comprising: encoding a bit position configured on a link in a bit position field of a BIER-TE sub-type length value (sub-TLV); and distributing the BIER-TE sub-TLV in the BIER-TE domain.

Optionally, in any of the preceding aspects, another implementation of the aspect provides that the bit position is encoded in the bit position field of the BIER-TE sub-TLV when a link type of a link in an open shortest path first version 2 (OSPFv2) TLV or in an open shortest path first version 3 (OSPFv3) TLV has a first value or a second value.

Optionally, in any of the preceding aspects, another implementation of the aspect provides that the first value indicates a point-to-point connection to another network node, and the second value indicates a connection to a transit network.

Optionally, in any of the preceding aspects, another implementation of the aspect provides that the BIER-TE sub-TLV is distributed to neighbor network nodes immediately adjacent to the network node.

Optionally, in any of the preceding aspects, another implementation of the aspect provides that the BIER-TE sub-TLV is an open shortest path first version 2 (OSPFv2) BIER-TE sub-TLV.

Optionally, in any of the preceding aspects, another implementation of the aspect provides that the OSPFv2 BIER-TE sub-TLV is distributed within an OSPFv2 extended link TLV of an OSPFv2 extended link opaque link state advertisement (LSA).

Optionally, in any of the preceding aspects, another implementation of the aspect provides that the BIER-TE sub-TLV is an open shortest path first version 3 (OSPFv3) BIER-TE sub-TLV.

Optionally, in any of the preceding aspects, another implementation of the aspect provides that the OSPFv3 BIER-TE sub-TLV is distributed within an OSPFv3 router link TLV of an OSPFv3 extended router link state advertisement (LSA).

Optionally, in any of the preceding aspects, another implementation of the aspect provides that the BIER-TE sub-TLV is an intermediate system-intermediate system (IS-IS) BIER-TE sub-TLV.

Optionally, in any of the preceding aspects, another implementation of the aspect provides that the IS-IS BIER-TE sub-TLV is distributed within an extended intermediate system (IS) reachability TLV of a multi-topology (MT) intermediate systems TLV.

Optionally, in any of the preceding aspects, another implementation of the aspect provides that the BIER-TE sub-TLV further comprises a designated router (DR) end bit position field configured to include a bit position of a connection on a DR end.

Optionally, in any of the preceding aspects, another implementation of the aspect provides that the BIER-TE sub-TLV further comprises one or more of a type field indicating that the BIER-TE sub-TLV is a BIER-TE sub-TLV, a length field indicating a length of the BIER-TE sub-TLV field, a sub-domain identifier field identifying the BIER-TE domain, a multi-topology identifier field identifying a topology associated with the BIER-TE domain, a BIER algorithm (BAR) field identifying the BIER algorithm used to calculate underlay paths, or an Interior Gateway Protocol (IGP) algorithm field identifying the IGP algorithm used to modify, enhance, or replace a calculation of underlay paths to reach other network nodes as defined by a BAR value.

Optionally, in any of the preceding aspects, another implementation of the aspect provides that the bit position field contains only a single bit position.

A second aspect relates to network node in a Bit Index Explicit Replication Traffic Engineering (BIER-TE) domain, comprising: a memory storing instructions; and one or more processors coupled to the memory, wherein the one or more processors are configured to execute the instructions to cause the network node to: encode a bit position configured on a link in a bit position field of a BIER-TE sub-type length value (sub-TLV); and distribute the BIER-TE sub-TLV in the BIER-TE domain.

Optionally, in any of the preceding aspects, another implementation of the aspect provides that the bit position is encoded in the bit position field of the BIER-TE sub-TLV when a link type of a link in an open shortest path first version 2 (OSPFv2) TLV or in an open shortest path first version 3 (OSPFv3) TLV has a first value or a second value.

Optionally, in any of the preceding aspects, another implementation of the aspect provides that the first value indicates a point-to-point connection to another network node, and the second value indicates a connection to a transit network.

Optionally, in any of the preceding aspects, another implementation of the aspect provides that the BIER-TE sub-TLV is distributed to neighbor network nodes immediately adjacent to the network node.

Optionally, in any of the preceding aspects, another implementation of the aspect provides that the BIER-TE sub-TLV is an open shortest path first version 2 (OSPFv2) BIER-TE sub-TLV.

Optionally, in any of the preceding aspects, another implementation of the aspect provides that the OSPFv2 BIER-TE sub-TLV is distributed within an OSPFv2 extended link TLV of an OSPFv2 extended link opaque link state advertisement (LSA).

Optionally, in any of the preceding aspects, another implementation of the aspect provides that the BIER-TE sub-TLV is an open shortest path first version 3 (OSPFv3) BIER-TE sub-TLV.

Optionally, in any of the preceding aspects, another implementation of the aspect provides that the OSPFv3 BIER-TE sub-TLV is distributed within an OSPFv3 router link TLV of an OSPFv3 extended router link state advertisement (LSA).

Optionally, in any of the preceding aspects, another implementation of the aspect provides that the BIER-TE sub-TLV is an intermediate system-intermediate system (IS-IS) BIER-TE sub-TLV.

Optionally, in any of the preceding aspects, another implementation of the aspect provides that the IS-IS BIER-TE sub-TLV is distributed within an extended intermediate system-intermediate system (IS-IS) (IS) reachability TLV of a multi-topology (MT) intermediate systems TLV.

Optionally, in any of the preceding aspects, another implementation of the aspect provides that the BIER-TE sub-TLV further comprises a designated router (DR) end bit position field configured to include a bit position of a connection on a DR end.

Optionally, in any of the preceding aspects, another implementation of the aspect provides that the BIER-TE sub-TLV further comprises one or more of a type field indicating that the BIER-TE sub-TLV is a BIER-TE sub-TLV, a length field indicating a length of the BIER-TE sub-TLV field, a sub-domain identifier field identifying the BIER-TE domain, a multi-topology identifier field identifying a topology associated with the BIER-TE domain, a BIER algorithm (BAR) field identifying the BIER algorithm used to calculate underlay paths, or an Interior Gateway Protocol (IGP) algorithm field identifying the IGP algorithm used to modify, enhance, or replace a calculation of underlay paths to reach other network nodes as defined by a BAR value.

Optionally, in any of the preceding aspects, another implementation of the aspect provides that the bit position field contains only a single bit position.

A third aspect relates to network node in a Bit Index Explicit Replication Traffic Engineering (BIER-TE) domain, comprising: means for encoding a bit position in a bit position field of a BIER-TE sub-type length value (sub-TLV); and means for distributing the BIER-TE sub-TLV in the BIER-TE domain.

A fourth aspect relates to a non-transitory computer readable medium comprising a computer program product for use by a network node, the computer program product comprising computer executable instructions stored on the non-transitory computer readable medium that, when executed by one or more processors, cause the network node to: encode a bit position in a bit position field of a Bit Index Explicit Replication Traffic Engineering (BIER-TE) sub-type length value (sub-TLV); and distribute the BIER-TE sub-TLV in a BIER-TE domain.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a BIER-TE topology including a BIER-TE domain.

FIG. 2 is a schematic diagram of a BIER-TE topology including a BIER-TE domain having a pseudo node.

FIG. 3 is a schematic diagram of a fast reroute bit index forwarding table (FRR-BIFT) of a network node.

FIG. 4 is a schematic diagram of an Open Shortest Path First version 2 (OSPFv2) extended link opaque link state announcement (LSA).

FIG. 5 is a schematic diagram of an OSPFv2 extended link opaque link type length value (TLV).

FIG. 6 is a schematic diagram of an OSPFv2 BIER-TE sub-TLV according to an embodiment of the disclosure.

FIG. 7 is a schematic diagram of an Open Shortest Path First version 3 (OSPFv3) extended router LSA.

FIG. 8 is a schematic diagram of an OSPFv3 router link TLV.

FIG. 9 is a schematic diagram of a multi-topology (MT) intermediate systems TLV (Type 222).

FIG. 10 is a schematic diagram of an extended intermediate system (IS) reachability TLV.

FIG. 11 is a schematic diagram of an IS-IS BIER-TE sub-TLV according to an embodiment of the disclosure.

FIG. 12 is a method implemented by a network node in the BIER-TE domain according to an embodiment of the disclosure.

FIG. 13 is a schematic diagram of a network apparatus according to an embodiment of the disclosure.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

The bit forwarding router identifier (BFR-id) of each bit forwarding egress router (BIHER) is distributed in the BIER-TE domain (a.k.a., BIER-TE network). However, there are no interior gateway protocol (IGP) (e.g., OSPFv2, OSPFv3, or Intermediate System-Intermediate System (IS-IS)) extensions that can be used to distribute Bit Positions (a.k.a., bit positions) configured on the links in the BIER-TE domain.

Disclosed herein are techniques allowing IGP to distribute Bit Positions configured on the links in a Bit Index Explicit Replication (BIER) Traffic/Tree Engineering (BIER-TE) domain. In order to facilitate the techniques, the present disclosure provides a BIER-TE sub-TLV that extends OSPFv2, OSPFv3, and IS-IS. Using the extensions, packet routing within the BIER-TE domain is improved relative to existing techniques.

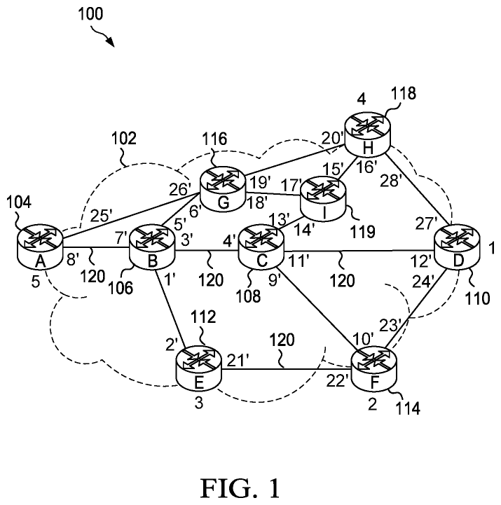

FIG. 1 is a schematic diagram of a BIER-TE topology 100 including a BIER-TE domain 102. The BIER-TE domain 102 may be part of a larger BIER-TE domain (not shown). As such, the BIER-TE domain 102 may be referred to herein as a BIER-TE sub-domain. The BIER-TE domain 102 comprises a plurality of network nodes 104, 106, 108, 110, 112, 114, 116, 118, and 119. While nine network nodes 104-119 are shown in the BIER-TE domain 102, more or fewer nodes may be included in practical applications.

For ease of discussion, all of the network nodes 104-119 have been given a letter designation. For example, the network node 104 has the designation A, the network node 106 has the designation B, the network node 108 has the designation C, the network node 110 has the designation D, the network node 112 has the designation E, the network node 114 has the designation F, the network node 116 has the designation G, the network node 118 has the designation H, and the network node 119 has the designation I.

Each of the network nodes 104-119 is a bit forwarding router (BFR). Some of the network nodes, namely the network nodes 104, 110, 112, 114 and 118, are disposed at an edge of the BIER-TE domain 102. The network nodes 104, 110, 112, 114 and 118 receiving multicast packets from outside the BIER-TE domain 102 may be referred to as an ingress BFR (BFIR). The network nodes 104, 110, 112, 114 and 118 transmitting multicast packets out of the BIER-TE domain 102 may be referred to as an egress BFR (BFER). Depending on the direction of multicast packet traffic, each of the network nodes 104-118 may function as a BFIR or a BFER.

As shown in FIG. 1, the bit position (BP) for forward connected (fw-con) adjacency between the various network nodes 104-119 is identified. In the illustrated example, the BP for a fw-con adjacency indicates how to reach an adjacent node and is represented as i′, where i is an integer corresponding to one of the forward connected adjacencies between the network nodes 104-119 in the BIER-TE domain 102. In the illustrated embodiment of FIG. 1, there are twenty-eight total BPs for twenty-eight fw-con adjacencies. However, there may be more or fewer BPs for fw-con adjacencies in other BIER-TE domains in practical applications. In an embodiment, a forwarding adjacency (a.k.a., forward-connected adjacency) is a traffic engineering label-switched path (LSP) configured between two nodes and used by the interior gateway protocol (IGP) to forward traffic. In an embodiment, the BP represents a forward connected adjacency.

As an example of how the BPs for fw-con adjacencies operate with regard to FIG. 1, 7′ is the BP for the fw-con adjacency from node 104 to node 106, and 8′ is the BP for the fw-con adjacency from node 106 to node 104. 7′ is configured on the link from node 104 to node 106 and advertised to all the network nodes in the network. 8′ is configured on the link from node 106 to node 104 and advertised to all the network nodes in the network. As another example, 12′ is the BP for the fw-con adjacency from node 108 to node 110, and 11′ is the BP for the fw-con adjacency from node 110 to node 108. 12′ is configured on the link from node 108 to node 110 and advertised to all the network nodes in the network. 11′ is configured on the link from node 110 to node 108 and advertised to all the network nodes in the network. Similarly, 14′ is the BP for the fw-con adjacency from node 108 to node 119, and 13′ is the BP for the fw-con adjacency from node 119 to node 108. 14′ is configured on the link from node 108 to node 119 and advertised to all the network nodes in the network. 13′ is configured on the link from node 119 to node 108 and advertised to all the network nodes in the network. The other BPs for fw-con adjacencies may be determined in a similar fashion as represented by the various values for i′ on FIG. 1. For ease of discussion, each BP for a fw-con adjacency may be simply referred to herein as the BP, the adjacency, or the BP for the adjacency.

Each of the network nodes 104, 110, 112, 114, and 118 may be referred to herein as a destination network node or egress BFR (BFER). The network nodes 104, 110, 112, 114 and 118 have each been assigned a BP, a set index (SI), and a BitString. The BP of a BFER is called a local decapsulation (decap) adjacency, a local decap BP, or the BFR-id. In the illustrated example, the BP of a BFER is represented as j, where j is an integer corresponding to one of the local decap adjacencies in the BIER-TE domain 102. In the illustrated embodiment of FIG. 1, there are five local decap adjacencies for five network nodes 104, 110, 112, 114 and 118 operating as BFERs. As an example, the BPs of network nodes 104, 110, 112, 114 and 118 are 5, 1, 3, 2 and 4, respectively. For simplicity, these BPs for local decap adjacencies are represented by (SI:BitString), where SI=0 and BitString is of 8 bits. BPs 1, 2, 3, 4, and 5 are collectively represented by 1 (0:00000001), 2 (0:00000010), 3 (0:00000100), 4 (0:00001000) and 5 (0:00010000), respectively. The BP of a BFER (a.k.a., the BFR-id) is advertised by the BFER to all the network nodes in the network.

In an embodiment, the BPs for fw-con adjacencies are represented by (SI:BitString), where SI>=6 and BitString is of 8 bits. For example, the BP of 2′ has a SI of 6, and has a BitString of 00000010 (collectively represented by 2′ (6:00000010)). The BP of 4′ has a SI of 6, and has a BitString of 00001000 (collectively represented by 4′ (6:00001000)). The BP of 6′ has a SI of 6, and has a BitString of 00100000 (collectively represented by 6′ (6:00100000)). The BP of 8′ has a SI of 6, and has a BitString of 10000000 (collectively represented by 8′ (6:10000000)). In this way, the BP is represented by a number that indicates which bit is set in the BitString.

Each of the network nodes 104-119 has one or more neighbor nodes. As used herein, a neighbor node refers to a network node that is only one hop away from the network node. For example, network node 106 has four neighbor nodes in FIG. 1, namely network node 104, network node 108, network node 112, and network node 116. Indeed, each of network node 104, network node 108, network node 112, and network node 116 are only one hop away from network node 106.

The network nodes 104-119 in FIG. 1 are coupled to, and communicate with each other, via links 120. The links 120 may be wired, wireless, or some combination thereof. Each of the links 120 may have a cost. The cost of each of the links 120 may be the same or different, depending on the BIER-TE network and conditions therein.

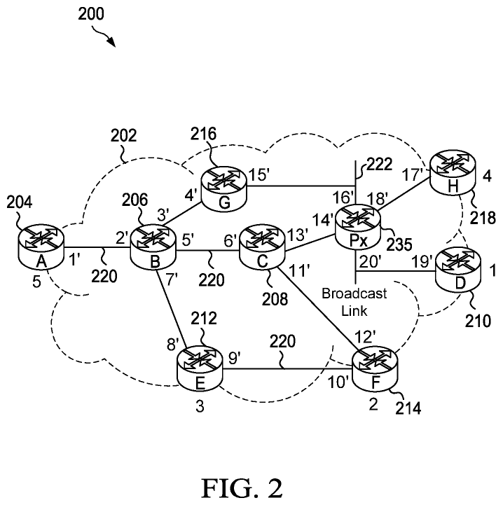

FIG. 2 is a schematic diagram of a BIER-TE topology 200 including a BIER-TE domain 202 having a pseudo node 235. The BIER-TE topology 200 is similar to the BIER-TE topology 100 of FIG. 1. For example, the BIER-TE topology 200 includes various network nodes 204, 206, 208, 210, 212, 214, 216, and 218 coupled together by links 220. The network nodes and links in FIG. 2 are similar to the network nodes and links in FIG. 1. Therefore, a description of like elements is not repeated herein.

Unlike the BIER-TE topology 100 of FIG. 1, the BIER-TE topology 200 of FIG. 2 includes the pseudo node 235 (e.g., network node Px). The pseudo node 235 is represented as being disposed on a broadcast link 222 (e.g., a local area network (LAN)) and having neighbor network nodes (i.e., next hops) including network node 216, network node 208, network node 218, and network node 210. In an embodiment, the pseudo node 235 is a designated router (DR) of the broadcast link in an Open Shortest Path First (OSPF) protocol. In an embodiment, the pseudo node 235 is a designated intermediate system (DIS) of the broadcast link in an Intermediate System-Intermediate System (IS-IS) protocol.

Each link 220 connecting the pseudo node 235 to one of the neighbor network nodes is assigned two BPs. One BP is for LAN-connected adjacency (a.k.a., the LAN adjacency) from the neighbor network node to the pseudo node 235, and the other BP is for the forward connected adjacency from the pseudo node 235 to neighbor network node. For example, the forward connected adjacency from the pseudo node 235 to network node 208 is assigned BP 13′, and the LAN-connected adjacency from network node 208 to the pseudo node 235 is assigned BP 14′. In addition, the forward connected adjacency from pseudo node 235 to network node 216 is assigned BP 15′, and the LAN-connected adjacency from network node 216 to pseudo node 235 is assigned BP 16′. Likewise, the forward connected adjacency from pseudo node 235 to network node 218 is assigned BP 17′, and the LAN-connected adjacency from network node 218 to pseudo node 235 is assigned BP 18′. Finally, the forward connected adjacency from pseudo node 235 to network node 210 is assigned BP 19′, and the LAN-connected adjacency from network node 210 to pseudo node 235 is assigned BP 20′.

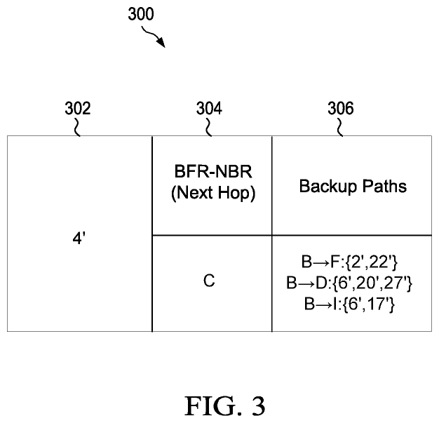

FIG. 3 is a schematic diagram of fast reroute bit index forwarding table (FRR-BIFT) 300 of a network node. Each of the network nodes in the BIER-TE topology 100, 200 in FIGS. 1-2 generates a fast reroute forwarding table similar to the FRR-BIFT 300. In an embodiment, the FRR-BIFT 300 is generated based on a bit index routing table (BIRT) and/or a bit index forwarding table (BIFT) (not shown) that the network nodes built.

The FRR-BIFT 300 depicted in FIG. 3 is a representative portion of the FRR-BIFT 300 built on the network node 106 in FIG. 1 or network node 206 in FIG. 2. The representative portion of the FRR-BIFT 300 is used to fast protect the failure of network node 108 in FIG. 1 or network node 208 in FIG. 2. As shown, the FRR-BIFT 300 includes three columns of information. The first column 302 identifies the BP for fw-con adjacency corresponding to the network node 108, 208. That is, the first column 302 indicates how the network node 106, 206 is able to reach the network node 108, 208 under normal operations (i.e., when there has not been a failure affecting the network node 108, 208).

A second column 304 identifies a neighbor node (BFR-NBR) of the network node 106, 206. During normal operations, the neighbor node may be reached using the adjacency identified in the first column 302, which is why the neighbor node in the second column 304 may also be referred to as the next hop of the network node 106. In the illustrated embodiment, the neighbor node in the second column is designated by the letter C, which corresponds to the network node 108, 208.

The third column 306 includes a backup path field. An entry in the backup path field identifies a backup path used to reach each next hop of a neighbor node of the network node when the neighbor node is operating abnormally or has failed. As shown in FIG. 3, the backup path may include one or more BPs (e.g., 2′, 22′) in an ordered set. As an example, the backup path field in the FRR-BIFT 300 identifies a backup path to each of the next hops of network node 108 (a.k.a., network node C) without going through node 108. The first backup path includes the expression B→F: {2′, 22′}. This expression indicates that the backup path from network node 106 to network node 114, which is the next hop of network node 108 (a.k.a., network node C) identified in the third column 306, is along forward connected adjacency 2′ (i.e., the BP of the forward connected adjacency from network node 106 to the network node 112) and then 22′ (i.e., the BP of the forward connected adjacency from network node 112 to the network node 114).

The second backup path includes the expression B→D: {6′, 20′, 27′}. This expression indicates that the backup path from network node 106 to network node 110 is along forward connected adjacency 6′ (i.e., the BP of the forward connected adjacency from network node 106 to the network node 116), then 20′ (i.e., the BP of the forward connected adjacency from network node 116 to the network node 118), and then 27′ (i.e., the BP of the forward connected adjacency from network node 118 to the network node 110). The third backup path includes the expression B→I: {6′, 17′}. This expression indicates that the backup path from network node 106 to network node 119 is along forward connected adjacency 6′ (i.e., the BP of the forward connected adjacency from network node 106 to the network node 116) and then 17′ (i.e., the BP of the forward connected adjacency from network node 116 to the network node 119).

Keeping the above in mind and referring back to FIG. 1, an example of how packets are routed during normal operations and how packets are routed during a failure is provided. During normal operations, when a packet is received at network node 104, the network node 104 adds or encapsulates a point to multipoint (P2MP) path into the packet. For example, the network node 104 adds the P2MP path from node A to nodes D and H {26′, 20′, 7′, 4′, 12′, 4, 1} into the received packet. Thereafter, the network node 104 removes its adjacencies 26′ and 7′ from the packet, makes a first copy of the packet, and transmits the first copy of the packet to network node 116 using adjacency 26′ (i.e., the forwarding entry for the forward connected adjacency 26′ in the FRR-BIFT built on the network node 104). The network node 104 also makes a second copy of the packet, removes its adjacencies 26′ and 7′ from the second copy, and sends the second copy to network node 106 using adjacency 7′ (i.e., the forwarding entry for the forward connected adjacency 7′ in the FRR-BIFT built on the network node 104).

The network node 116 receives the packet, which now contains the path {20′, 4′, 12′, 4, 1}. The network node 116 removes its adjacency 20′ from the packet and transmits the packet to network node 118 using adjacency 20′ (i.e., the forwarding entry for the forward connected adjacency 20′ in the FRR-BIFT built on the network node 116). The network node 118 receives the packet, which now contains the path {4′, 12′, 4, 1}. The network node 118 decapsulates the packet with BP=4 for BFER H (i.e., egress node118) and transmits the payload of the packet to the multicast overlay.

The network node 106 receives the packet, which contains the path {20′, 4′, 12′, 4, 1}. The network node 106 removes its adjacency 4′ from the packet and transmits the packet to network node 108 using adjacency 4′ (i.e., the forwarding entry for the forward connected adjacency 4′ in the FRR-BIFT built on the network node 106). The network node 108 receives the packet, which contains the path {20′, 12′, 4, 1}. The network node 108 removes its adjacency 12′ from the packet and transmits the packet to network node 110 using adjacency 12′ (i.e., the forwarding entry for the forward connected adjacency 12′ in the FRR-BIFT built on the network node 108). The network node 110 receives the packet, which now contains the path {20′, 4, 1}. The network node 118 decapsulates the packet with BP=1 for BFER D (i.e., egress node 110) and transmits the payload of the packet to the multicast overlay.

During abnormal operations (e.g., network node 108 has failed), when a packet is received at network node 104, the network node 104 adds or encapsulates a point to multipoint (P2MP) path into the packet. For example, the network node 104 adds the path from node A to nodes D and H {26′, 20′, 7′, 4′, 12′, 4, 1} into the received packet. Thereafter, the network node 104 removes its adjacencies 26′ and 7′ from the packet, makes a first copy of the packet, and transmits the first copy of the packet to network node 116 using adjacency 26′. The network node 104 also makes a second copy of the packet, and sends the second copy to network node 106 using adjacency 7′.

The network node 116 receives the packet, which now contains the path {20′, 4′, 12′, 4, 1}. The network node 116 removes its adjacency 20′ from the packet and transmits the packet to network node 118 using adjacency 20′. The network node 118 receives the packet, which now contains the path {4′, 12′, 4, 1}. The network node 118 decapsulates the packet with BP=4 and transmits the payload of the packet to the multicast overlay.

The network node 106 receives the packet, which contains the path {20′, 4′, 12′, 4, 1}. The network node 106 removes its adjacency 4′ from the packet. Since network node 108, which is a neighbor node of the network node 106, has failed, the network node 106 removes BP 12′ for the forward connected adjacency from the failed node 108 to the network node 110 that is a next hop of the failed node 108 and is on the path in the packet, removes the BP 4 (i.e., the local decap adjacency of BFER H) from the path of the packet that is on the backup path because BFER H is not on a path branch of the path in the packet from network node 106, and adds the BPs for the backup path from network node 106 to network node 110. The added BPs are {6′, 27′}. Thus, the packet now contains the path {6′, 20′, 27′, 1}. Thereafter, network node 106 removes its adjacency 6′ from the packet and transmits the packet to network node 116 using adjacency 6′.

The network node 116 receives the packet, which contains the path {20′, 27′, 1}. The network node 116 removes its adjacency 20′ from the packet and transmits the packet to network node 118 using adjacency 20′. The network node 118 receives the packet, which now contains the path {27′, 1}. The network node 118 removes its adjacency 27′ from the packet and transmits the packet to network node 110 using adjacency 27′. The network node 110 receives the packet, which now contains the path 111. The network node 110 decapsulates the packet with BP=1 for BFER D (i.e., egress node 110) and transmits the payload of the packet to the multicast overlay.

The packet routing in the BIER-TE domain 202 of FIG. 2 is similar to the packet routing in the BIER-TE domain 102 of FIG. 1. That is, even though the BIER-TE domain 202 includes the pseudo node 235 (which is not physically present), the packet routing still occurs in the same general manner as described above using the adjacencies.

While the BIER-TE domain 102, 202 are suitable for packet routing, there are no IGP extensions that can be used to distribute Bit Positions configured on the links in the BIER-TE domains 102, 202. Therefore, the present disclosure provides a BIER-TE sub-TLV that extends OSPFv2, OSPFv3, and IS-IS. Examples of the BIER-TE sub-TLV are provided below.

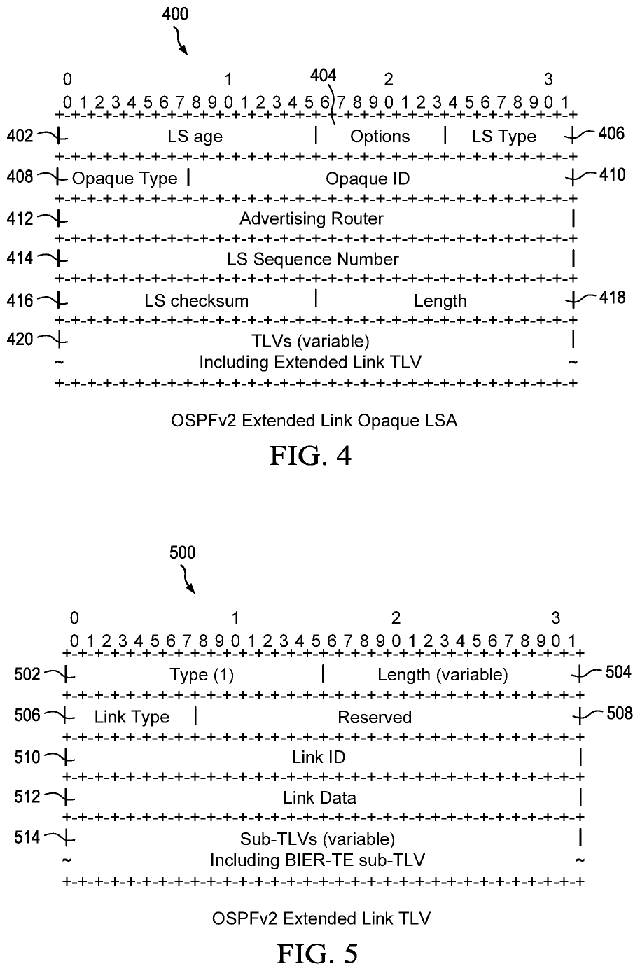

FIG. 4 is a schematic diagram of an OSPFv2 extended link opaque LSA 400. The OSPFv2 extended link opaque LSA 400 includes a link state (LS) age field 402, an options 404 field, an LS type field 406, an opaque type field 408, an opaque ID field 410, an advertising router filed 412, an LS sequence number field 414, an LS checksum field 416, a length filed 418, and a TLVs field 420. Details regarding one or more of these fields may be found in Internet Engineering Task Force (IETF) document Request for Comments (RFC) 7684 entitled “OSPFv2 Prefix/Link Attribute Advertisement” by P. Psenak, et al., published November 2015, and IETF document RFC 5250 entitled “The OSPF Opaque LSA Option” by L. Berger, et al., published July 2008.

FIG. 5 is a schematic diagram of an OSPFv2 extended link opaque TLV 500. The OSPFv2 extended link opaque TLV 500 may be included in the TLVs field 420 of the OSPFv2 extended link opaque LSA 400 in FIG. 4. The OSPFv2 extended link opaque TLV 500 includes a type field 502, a length field 504, a link type field 506, a reserved field 508, a link ID field 510, a link data field 512, and a sub-TLVs field 514. Details regarding one or more of these fields may be found in IETF document RFC 7684 entitled “OSPFv2 Prefix/Link Attribute Advertisement” by P. Psenak, et al., published November 2015, and IETF document RFC 5250 entitled “The OSPF Opaque LSA Option” by L. Berger, et al., published July 2008.

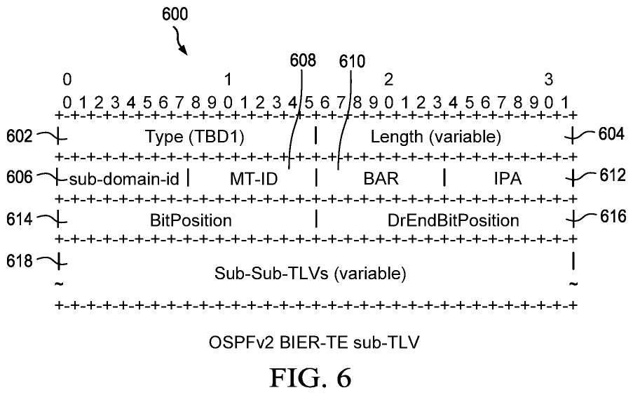

FIG. 6 is a schematic diagram of an OSPFv2 BIER-TE sub-TLV 600 according to an embodiment of the disclosure. The OSPFv2 BIER-TE sub-TLV 600 may be included in the sub-TLVs field 514 of the OSPFv2 extended link opaque TLV 500 in FIG. 5. The OSPFv2 BIER-TE sub-TLV 600 includes a type field 602, a length field 604, a sub-domain ID field 606, an MT-ID field 608, a BIER algorithm (BAR) field 610, an IGP algorithm field 612, a BitPosition field 614, a DrEndBitPosition field 616, and a sub-sub-TLVs field 618.

The type field 602 is 16 bits and includes a value that indicates the type of sub-TLV. In an embodiment, the value is to be assigned by the Internet Assigned Numbers Authority (LANA) and is to be determined (TBD). The length field 604 is 16 bits and includes a value that indicates a length of the sub-TLV, exclusive of the type field 602 and the length field 604.

The sub-domain ID field 606 is 8 bits and includes a value that identifies a BIER-TE sub-domain (e.g., the BIER-TE domain 102). The MT-ID field 608 is 8 bits and includes a value that identifies the topology (e.g., OSPFv2, OSPFv3, IS-IS) associated with the sub-domain. The BAR field 610 includes a value that identifies the BIER algorithm used to calculate underlay paths to other BFRs. The IPA field 612 includes a value that identifies the IGP algorithm used to modify, enhance, or replace the calculation of underlay paths to reach other BFRs as defined by the value in the BAR field 610.

The BitPosition field 614 includes a value that identifies the bit position (a.k.a., BitPosition) locally configured on a point-to-point (P2P) link (e.g., link 120) or on a broadcast link (e.g., link 222). That is, the BitPosition field 614 is configured to carry a bit position such as, for example, bit position 4′. In an embodiment, the BitPosition field 614 contains only a single bit position. When a network node advertises a bit position on a link attached to the network node, the OSPFv2 BIER-TE sub-TLV 600 may be utilized. By sending the OSPFv2 BIER-TE sub-TLV 600 to a neighbor node sending the sub-TLV to its neighbor nodes, a network node is able to report the bit position configured on the link (a.k.a., the BP for forward connected adjacency) as well as the information in the other fields to the neighbor node and other network nodes.

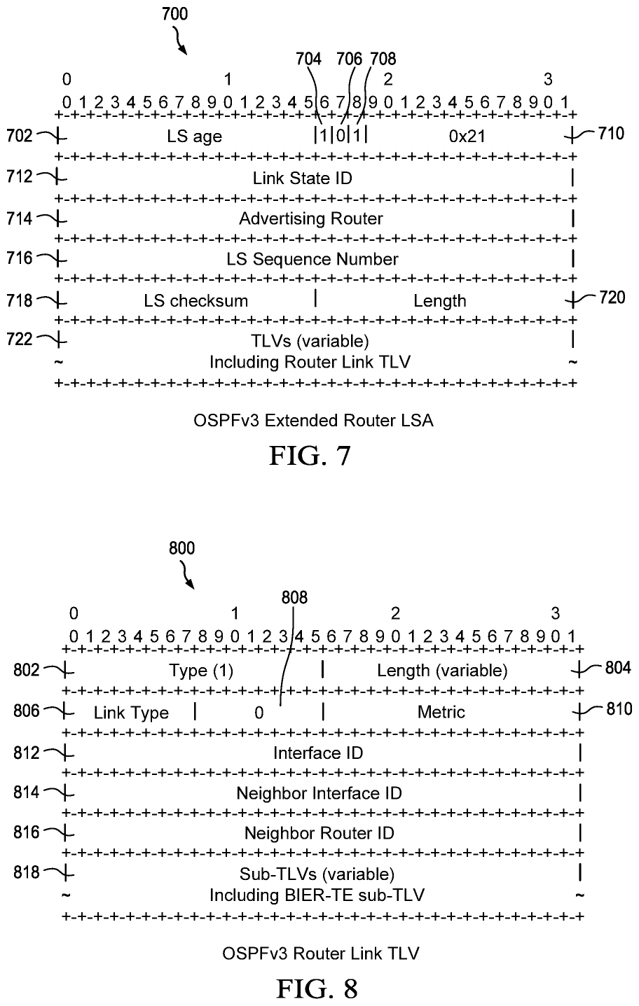

FIG. 7 is a schematic diagram of an OSPFv3 extended router LSA 700. The OSPFv3 extended router LSA 700 includes an LS age field 702, a first binary field 704, a second binary field 706, a third binary field 708, a type field 710, a link state ID field 712, an advertising router field 714, an LS sequence number field 716, an LS checksum field 718, a length field 720, and a TLVs field 722. Details regarding one or more of these fields may be found in IETF document RFC 8362 entitled “OSPFv3 Link State Advertisement (LSA) Extensibility” by A. Lindem, et al., published April 2018.

FIG. 8 is a schematic diagram of an OSPFv3 router link TLV 800. The OSPFv3 router link TLV 800 may be included in the TLVs field 722 of the OSPFv3 extended router LSA 700. The OSPFv3 router link TLV 800 includes a type field 802, a length field 804, a link type field 806, a first binary field 808, a metric field 810, an interface ID field 812, a neighbor interface ID field 814, a neighbor router ID field 816, and a sub-TLVs field 818. Details regarding one or more of these fields may be found in IETF document RFC 8362 entitled “OSPFv3 Link State Advertisement (LSA) Extensibility” by A. Lindem, et al., published April 2018.

The sub-TLVs field 818 is configured to include the OSPFv2 BIER-TE sub-TLV 600 as shown in FIG. 6 and as described herein. When a network node advertises a bit position on a link attached to the network node, the OSPFv3 BIER-TE sub-TLV 600 may be utilized.

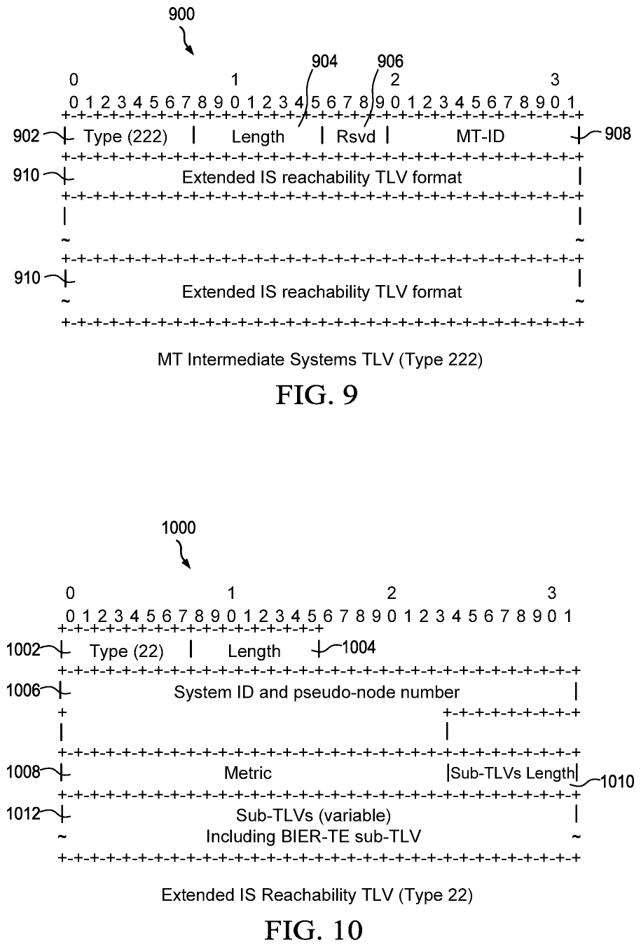

FIG. 9 is a schematic diagram of a MT intermediate systems TLV (Type 222) 900. The MT intermediate systems TLV (Type 222) 900 includes a type field 902, a length field 904, a reserved field 906, an MT-ID field 908, and one or more extended IS reachability TLV format fields 910. Details regarding one or more of these fields may be found in IETF document RFC 5120 entitled “M-ISIS: Multi Topology (MT) Routing in Intermediate System to Intermediate Systems (IS-ISs)” by T. Przygienda, et al., published February 2008.

FIG. 10 is a schematic diagram of an extended IS reachability TLV 1000. The extended IS reachability TLV 1000 may be included in the extended IS reachability TLV format field 910 of FIG. 9. The extended IS reachability TLV 1000 includes a type field 1002, a length field 1004, a system ID and pseudo-node number field 1006, a metric field 1008, a sub-TLVs length field 1010, and a sub-TLVs field 1012. Details regarding one or more of these fields may be found in IETF document RFC 5120 entitled “M-ISIS: Multi Topology (MT) Routing in Intermediate System to Intermediate Systems (IS-ISs)” by T. Przygienda, et al., published February 2008.

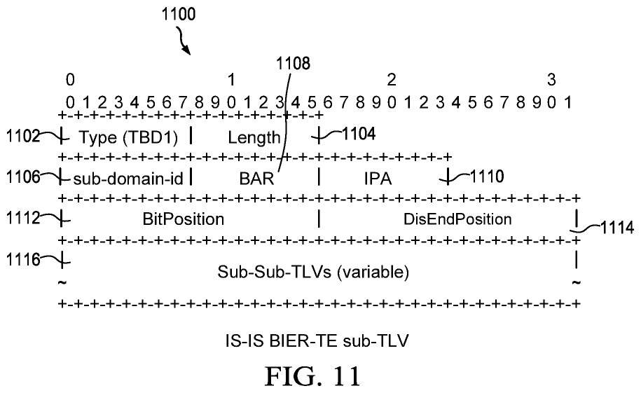

FIG. 11 is a schematic diagram of an IS-IS BIER-TE sub-TLV 1100 according to an embodiment of the disclosure. The IS-IS BIER-TE sub-TLV 1100 may be included in the sub-TLVs field 1012 of FIG. 10. The IS-IS BIER-TE sub-TLV 1100 includes a type field 1102, a length field 1104, a sub-domain ID field 1106, a BAR field 1108, an IPA field 1110, a BitPosition field 1112, a DisEndPosition field 1114, and a sub-sub-TLVs field 1116.

The type field 1102 is 8 bits and includes a value that indicates the type of sub-TLV. In an embodiment, the value is to be assigned by the LANA and is to be determined (TBD). The length field 1104 is 8 bits and includes a value that indicates a length of the sub-TLV, exclusive of the type field 1102 and the length field 1104.

The sub-domain ID field 1106 is 8 bits and includes a value that identifies a BIER-TE sub-domain (e.g., the BIER-TE domain 102). The BAR field 1108 includes a value that identifies the BIER algorithm used to calculate underlay paths to other BFRs. The IPA field 1110 includes a value that identifies the IGP algorithm used to modify, enhance, or replace the calculation of underlay paths to reach other BFRs as defined by the value in the BAR field 1108.

The BitPosition field 1112 includes a value that identifies the bit position (a.k.a., BitPosition) locally configured on a P2P link (e.g., link 120) or on a broadcast link (e.g., link 222). That is, the BitPosition field 1112 is configured to carry a bit position such as, for example, bit position 4′. In an embodiment, the BitPosition field 1112 contains only a single bit position. When a network node advertises a bit position on a link attached to the network node, the IS-IS BIER-TE sub-TLV 1100 may be utilized. By sending the IS-IS BIER-TE sub-TLV 1100 to a neighbor node, a network node is able to report the bit position configured on the link (a.k.a., the BP for forward connected adjacency) as well as the information in the other fields to the neighbor node.

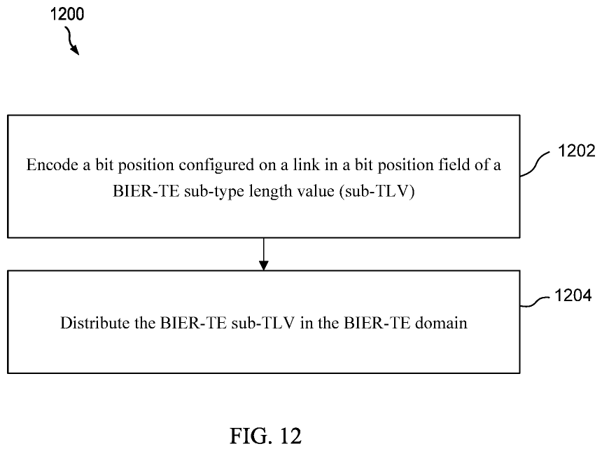

FIG. 12 is a method 1200 implemented by a network node (e.g., network node 106) in the BIER-TE domain according to an embodiment of the disclosure. The method may be performed by the network node to facilitate the distribution of Bit Positions to network nodes within the BIER-TE domain.

In block 1202, the network node encodes a bit position configured on a link in a bit position field of a BIER-TE sub-TLV. In an embodiment, the bit position is a bit position of (a.k.a., locally configured on) a link/interface of the network node. For example, the network node 104 is configured to encode the bit position 26′ in the bit position field of the BIER-TE sub-TLV to represent that the network node 104 is able to reach the network node 116 (which is immediately adjacent to the network node 114) using the link 120 that starts at the network node 104 and ends at the network node 116.

In an embodiment, the bit position is encoded in the bit position field of the BIER-TE sub-TLV when a link type of a link in an OSPFv2 TLV or in an OSPFv3 TLV has a first value (e.g., 1) or a second value (e.g., 2). In an embodiment, the first value indicates a point-to-point connection to another network node. In an embodiment, the second value indicates a connection to a transit network.

In an embodiment, the BIER-TE sub-TLV is an OSPFv2 BIER-TE sub-TLV (e.g., the OSPFv2 BIER-TE sub-TLV 600). In an embodiment, the BIER-TE sub-TLV is an OSPFv3 BIER-TE sub-TLV (which is similar or identical to the OSPF v2 BIER-TE sub-TLV 600). In an embodiment, the BIER-TE sub-TLV is an IS-IS BIER-TE sub-TLV (e.g., the IS-IS BIER-TE sub-TLV 1100).

In an embodiment, the BIER-TE sub-TLV further comprises a DR end bit position field configured to include a bit position of a connection on a DR end. The DR end bit position field may be the DrEndBitPosition field 616. In an embodiment, the DR end is a connection to a pseudo node. The DrEndBitPosition field 616 may include a bit position of the connection from a network node to the pseudo node representing a broadcast link or a LAN.

In an embodiment, the BIER-TE sub-TLV further comprises one or more of a type field indicating that the BIER-TE sub-TLV is a BIER-TE sub-TLV, a length field indicating a length of the BIER-TE sub-TLV field, a sub-domain identifier field identifying the BIER-TE domain, a multi-topology identifier field identifying a topology associated with the BIER-TE domain, a BIER algorithm (BAR) field identifying the BIER algorithm used to calculate underlay paths, or an Interior Gateway Protocol (IGP) algorithm field used to modify, enhance, or replace a calculation of underlay paths to reach other network nodes as defined by a BAR value.

In an embodiment, the bit position field contains only a single bit position. In such cases, the network node distributes a separate BIER-TE sub-TLV with one bit position to each neighbor node.

In block 1204, the network node distributes (e.g., transmits, sends, forwards) the BIER-TE sub-TLV in the BIER-TE domain. In an embodiment, the OSPFv2 BIER-TE sub-TLV is distributed within an OSPFv2 extended link TLV (e.g., the OSPFv2 extended link TLV 500) of an OSPFv2 extended link opaque LSA (e.g., the OSPFv2 extended link opaque LSA 400). In an embodiment, the OSPFv3 BIER-TE sub-TLV is distributed within an OSPFv3 router link TLV (e.g., OSPFv3 router link TLV 800) of an OSPFv3 extended router LSA (e.g., OSPFv3 extended router LSA 700). In an embodiment, the IS-IS BIER-TE sub-TLV is distributed within an extended IS reachability TLV (e.g., extended IS reachability TLV 1000) of a MT intermediate systems TLV (e.g., MT intermediate systems TLV 900). In an embodiment, the BIER-TE sub-TLV is distributed to neighbor network nodes immediately adjacent to the network node. For example, the network node 104 distributes the BIER-TE sub-TLV to the network nodes 116, 106 since the network nodes 116, 106 are immediately adjacent to the network node 104. In an embodiment, immediately adjacent means that one network node is directly connected to another network node. That is, there are no network nodes disposed between two immediately adjacent network nodes.

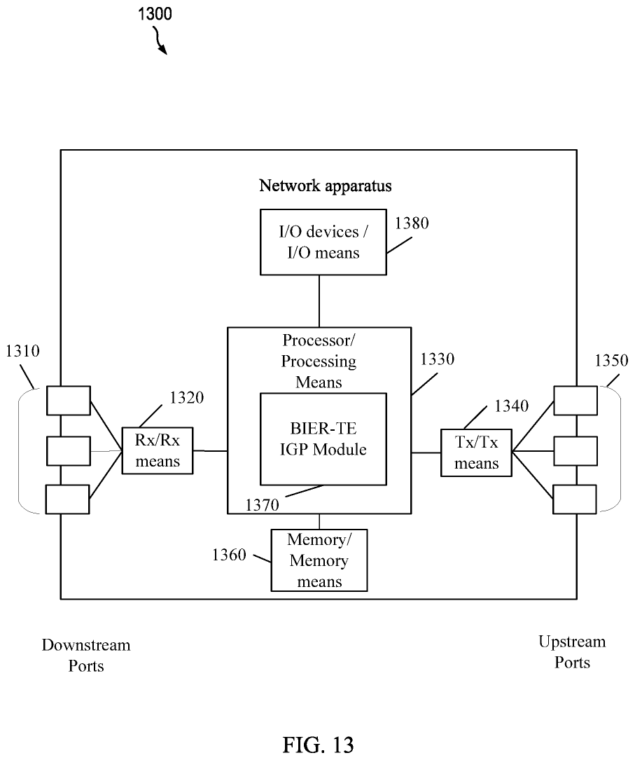

FIG. 13 is a schematic diagram of a network apparatus 1300 (e.g., a network node, a destination node, a neighbor node, etc.). The network apparatus 1300 is suitable for implementing the disclosed embodiments as described herein. The network apparatus 1300 comprises ingress ports/ingress means 1310 and receiver units (Rx)/receiving means 1320 for receiving data; a processor, logic unit, or central processing unit (CPU)/processing means 1330 to process the data; transmitter units (Tx)/transmitting means 1340 and egress ports/egress means 1350 for transmitting the data; and a memory/memory means 1360 for storing the data. The network apparatus 1300 may also comprise optical-to-electrical (OE) components and electrical-to-optical (EO) components coupled to the ingress ports/ingress means 1310, the receiver units/receiving means 1320, the transmitter units/transmitting means 1340, and the egress ports/egress means 1350 for egress or ingress of optical or electrical signals.

The processor/processing means 1330 is implemented by hardware and software. The processor/processing means 1330 may be implemented as one or more CPU chips, cores (e.g., as a multi-core processor), field-programmable gate arrays (FPGAs), application specific integrated circuits (ASICs), and digital signal processors (DSPs). The processor/processing means 1330 is in communication with the ingress ports/ingress means 1310, receiver units/receiving means 1320, transmitter units/transmitting means 1340, egress ports/egress means 1350, and memory/memory means 1360. The processor/processing means 1330 comprises a BIER-TE IGP module 1370. The BIER-TE IGP module 1370 is able to implement the methods disclosed herein. The inclusion of the BIER-TE IGP module 1370 therefore provides a substantial improvement to the functionality of the network apparatus 1300 and effects a transformation of the network apparatus 1300 to a different state. Alternatively, the BIER-TE IGP module 1370 is implemented as instructions stored in the memory/memory means 1360 and executed by the processor/processing means 1330.

The network apparatus 1300 may also include input and/or output (I/O) devices or I/O means 1380 for communicating data to and from a user. The I/O devices or I/O means 1380 may include output devices such as a display for displaying video data, speakers for outputting audio data, etc. The I/O devices or I/O means 1380 may also include input devices, such as a keyboard, mouse, trackball, etc., and/or corresponding interfaces for interacting with such output devices.

The memory/memory means 1360 comprises one or more disks, tape drives, and solid-state drives and may be used as an over-flow data storage device, to store programs when such programs are selected for execution, and to store instructions and data that are read during program execution. The memory/memory means 1360 may be volatile and/or non-volatile and may be read-only memory (ROM), random access memory (RAM), ternary content-addressable memory (TCAM), and/or static random-access memory (SRAM).

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other examples of changes, substitutions, and alterations are ascertainable by one skilled in the art and may be made without departing from the spirit and scope disclosed herein.

What is claimed is:

1. A method implemented by a network node in a Bit Index Explicit Replication Traffic Engineering (BIER-TE) domain, comprising:
encoding a bit position configured on a link in a bit position field of a sub-type length value (sub-TLV); and
distributing the sub-TLV in the BIER-TE domain.

2. The method of claim 1, wherein the bit position is encoded in the bit position field of the sub-TLV when a link type of a link in an open shortest path first version 2 (OSPFv2) TLV or in an open shortest path first version 3 (OSPFv3) TLV has a first value or a second value.

3. The method of claim 2, wherein the first value indicates a point-to-point connection to another network node, and wherein the second value indicates a connection to a transit network.

4. The method of claim 1, wherein the sub-TLV is distributed to neighbor network nodes immediately adjacent to the network node.

5. The method of claim 1, wherein the sub-TLV is an open shortest path first version 2 (OSPFv2) sub-TLV.

6. The method of claim 5, wherein the OSPFv2 sub-TLV is distributed within an OSPFv2 extended link TLV of an OSPFv2 extended link opaque link state advertisement (LSA).

7. The method of claim 1, wherein the sub-TLV is an open shortest path first version 3 (OSPFv3) sub-TLV.

8. The method of claim 7, wherein the OSPFv3 sub-TLV is distributed within an OSPFv3 router link TLV of an OSPFv3 extended router link state advertisement (LSA).

9. The method of claim 1, wherein the sub-TLV is an intermediate system-intermediate system (IS-IS) sub-TLV.

10. The method of claim 9, wherein the IS-IS sub-TLV is distributed within an extended intermediate system (IS) reachability TLV of a multi-topology (MT) intermediate systems TLV.

11. The method of claim 1, wherein the sub-TLV further comprises a designated router (DR) end bit position field configured to include a bit position of a connection on a DR end.

12. The method of claim 1, wherein the sub-TLV further comprises one or more of a type field indicating that the sub-TLV is a sub-TLV for a link bit position (BP), a length field indicating a length of the sub-TLV field, a sub-domain identifier field identifying the BIER-TE domain, a multi-topology identifier field identifying a topology associated with the BIER-TE domain, a BIER algorithm (BAR) field identifying the BIER algorithm used to calculate underlay paths, or an Interior Gateway Protocol (IGP) algorithm field identifying the IGP algorithm used to modify, enhance, or replace a calculation of underlay paths to reach other network nodes as defined by a BAR value.

13. The method of claim 1, wherein the bit position field contains only a single bit position.

14. A network node in a Bit Index Explicit Replication Traffic Engineering (BIER-TE) domain, comprising:
a memory storing instructions; and
one or more processors coupled to the memory, wherein the one or more processors are configured to execute the instructions to cause the network node to:
encode a bit position configured on a link in a bit position field of a sub-type length value (sub-TLV); and
distribute the sub-TLV in the BIER-TE domain.

15. The network node of claim 14, wherein the bit position is encoded in the bit position field of the sub-TLV when a link type of a link in an open shortest path first version 2 (OSPFv2) TLV or in an open shortest path first version 3 (OSPFv3) TLV has a first value or a second value.

16. The network node of claim 15, wherein the first value indicates a point-to-point connection to another network node, and wherein the second value indicates a connection to a transit network.

17. The network node of claim 14, wherein the sub-TLV is distributed to neighbor network nodes immediately adjacent to the network node.

18. The network node of claim 14, wherein the sub-TLV is an open shortest path first version 2 (OSPFv2) sub-TLV.

19. The network node of claim 18, wherein the OSPFv2 sub-TLV is distributed within an OSPFv2 extended link TLV of an OSPFv2 extended link opaque link state advertisement (LSA).

20. The network node of claim 14, wherein the sub-TLV is an open shortest path first version 3 (OSPFv3) sub-TLV.

21. The network node of claim 20, wherein the OSPFv3 sub-TLV is distributed within an OSPFv3 router link TLV of an OSPFv3 extended router link state advertisement (LSA).

22. The network node of claim 14, wherein the sub-TLV is an intermediate system-intermediate system (IS-IS) sub-TLV.

23. The network node of claim 22, wherein the IS-IS sub-TLV is distributed within an extended intermediate system (IS) reachability TLV of a multi-topology (MT) intermediate systems TLV.

24. The network node of claim 22, wherein the sub-TLV further comprises a designated router (DR) end bit position field configured to include a bit position of a connection on a DR end.

25. The network node of claim 14, wherein the sub-TLV further comprises one or more of a type field indicating that the sub-TLV is a sub-TLV, a length field indicating a length of the sub-TLV field, a sub-domain identifier field identifying the BIER-TE domain, a multi-topology identifier field identifying a topology associated with the BIER-TE domain, a BIER algorithm (BAR) field identifying the BIER algorithm used to calculate underlay paths, or an Interior Gateway Protocol (IGP) algorithm field identifying the IGP algorithm used to modify, enhance, or replace a calculation of underlay paths to reach other network nodes as defined by a BAR value.

26. The network node of claim 14, wherein the bit position field contains only a single bit position.
